(19) United States
(12) Patent Application Publication
(10) Pub. No.: US 2021/0266398 A1
(43) Pub. Date: Aug. 26, 2021

(54) Method and apparatus of using Morse code input combined with text-to-speech output for eyes-free, quiet, discreet and partially hands-free mobile text messaging

(71) Applicants: Alexander Povzner, Vaughan (CA); Ilia Masliev, East Gwillimbury (CA)

(72) Inventors: Alexander Povzner, Vaughan (CA); Ilia Masliev, East Gwillimbury (CA)

(21) Appl. No.: 16/801,818

(22) Filed: Feb. 26, 2020

(51) Int. Cl. H04M 1/725; G10L 13/04; H04L 15/00

(52) U.S. Cl. CPC H04M 1/72552; H04L 15/00; G10L 13/043

(57) ABSTRACT

The invention describes a method for sending and receiving text messages by a correspondent to/from another party using a mobile phone or other mobile device where the correspondent inputs the required text to the device in Morse code without the use of the correspondent's vision (eyes) and the correspondent's voice, while requiring a minimal employment of only one of the correspondent's hands or arms. The Morse code consists of only the symbols “dot” and “dash” and can be entered “blindly” with an input device having the barest minimum amount of sensors. The invented method of texting is being facilitated by audio guidance produced by the mobile device's text-to-speech synthesizer and played to the correspondent (possibly privately) through an audio reproduction system attached, connected to, or built into the mobile device. The invented method of mobile text messaging does not require the correspondent's vision, thus freeing the correspondent's eyes for other activities. By not requiring the correspondent's spoken voice the invention allows discreet and private mobile text messaging in the presence of other individuals, as well as making it possible to communicate in noisy environments where using voice recognition to enter text would not be viable. By reducing the employment of the correspondent's hands/arms to only a limited use of a single hand/arm, this invention can address text messaging scenarios where hands are needed for other tasks, for instance walking or driving a vehicle.

### FIELD OF THE INVENTION

The invention belongs to the field of electronic communications and more specifically to the field of mobile text messaging.

### BACKGROUND OF THE INVENTION

Proliferation of portable electronic devices and more specifically smart phones and smart pads that are continuously connected to a wireless or cellular network increasingly makes these mobile devices the preferred means of exchanging both personal and business messages between a correspondent in possession of such a device and other parties. While conventional voice calling with mobile devices is still frequent, such use of the mobile devices is nowadays diminishing due to the significant risk of the other party not being able to answer the call immediately, which presents the correspondent with two poor choices of trying to make another call later or sending a voice message to a voicemail. Recorded voice messages take some time to listen to and reply and are somewhat of a burden to manage. That is why the culture of exchanging text messages (called “texting”) is rapidly growing in popularity, due to the conveniently asynchronous mode of message exchange that does not commit both parties to the conversation at the same time. However, there are many contexts in which texting today is not viable, no matter how attractive as a means of communication. Specifically, those contexts where eyesight is extensively used, such as in driving, walking or attending a meeting or presentation, texting is normally ruled out because it relies on the necessity for the correspondent to see the keyboard and/or the screen of the mobile device in order to compose, send, receive and read text messages. In many cases, this shortfall can be addressed by using voice assistants that recognize human speech and thus free up both the vision and the hands of the correspondent. However, there is still a substantial set of contexts where voice assistance is not a viable option, such as noisy environments, environments that require for the correspondent to remain silent or presence of individuals for which the communication is not intended. Therefore, there is room for a new method and apparatus that would address those circumstances where neither the correspondent's vision nor the correspondent's voice can be used as a means of communication with the mobile device in order to facilitate text messaging.

The contemporary culture of texting relies on the method of receiving text messages by reading them on the screen of the mobile device, thus engaging the vision of the correspondent for the time needed to read the message. The sending of text messages in most cases is accomplished by pressing buttons on a keyboard or device surface, again using the vision of the correspondent for both the desired key location and for editing message displayed on the screen for its content and spelling mistakes. It is precisely the usage of the correspondent's vision that makes text messaging difficult in situations where the vision is required for other important tasks. Employment of vision in mobile texting is among the main reasons why texting is prohibited while driving a vehicle in many jurisdictions.

One of the existing methods of addressing the problem involves employment of “hands free”, voice assistance-based method. In a hands free, voice assistance-based method of communication, the text message can be read aloud through the speech synthesizer of the mobile device, and the reply message composition can be accomplished using the correspondent's voice picked up by the mobile device microphone and converted to text using speech recognition software installed on the device. This method some disadvantages. Firstly, the communication using speech recognition is not private. If another person is within hearing distance of the correspondence's voice (for instance is being seated within the same vehicle), the other person can overhear the content of the message. Secondly, the method is not viable for noisy environments or environments that require for the correspondent to remain silent, such as during a meeting.

Recently a method of character input for mobile devices using Morse code was disclosed in (Ref. 1) and was later made available in the industry (Ref. 2) to increase accessibility of mobile communication for persons that cannot use conventional external or internal keyboard of the device (for instance due to disability or other impairment). The Morse code, only having the two symbols “dot” and “dash”, is employed in the cited applications to drastically reduce the amount of input keys or sensors and to simplify the message composition. The feedback (the composed message) is provided visually with an on-screen display. Thus the use of the method of (Ref. 2) with a device (Ref. 1) still requires usage of vision (eyes) for tasks besides the message composition, such as reading the incoming message(s), editing the composed message, and navigating the contacts and message directory. Therefore texting using the method of character input of (Ref. 2) is not eyes-free, unlike the current invention.

### BRIEF SUMMARY OF THE INVENTION

The invention discloses a method of sending and receiving text messages without using the correspondent's vision and spoken voice, while requiring a minimal employment of only one of the correspondent's hands or arms, thereby making text messaging eyes-free, quiet and for the most part hands-free. In one example of the method application, a correspondent can walk or drive a car and simultaneously engage in a text messaging-based conversation with one or several parties. This is because the invented method only requires vision-free quiet manual manipulation of an input device with a very few sensors attached to, connected to, or built into the mobile device and similarly receiving vision-free feedback from the mobile device by listening to its audio output, privately or otherwise. The use of Morse code (having only two symbols “dot” and “dash” leads to a drastic reduction of the amount of sensors needed for the character input, thus the text input using Morse code can be performed “blindly” (without looking at the device) and with only a limited use of a single hand/arm. To receive feedback or system messages from the device, in order for instance to play back the input character or phrase, the correspondent can (possibly privately) listen to the audio output of the device through for instance a personal headset or a personal headphone. To facilitate other messaging tasks, such as listing the directory of callers, listing messages, editing the message, or entering or exiting the conversation, the input device can be supplied with a few command sensors. These other tasks often require additional character or text input (such as to spell the party name or message search criteria), which text input in our invention is again sent in Morse code using the same technique as for message text. The invented method thus enables the correspondent to conduct a quiet discreet communication not involving the correspondent's vision or spoken voice and allowing (for the most part) free use of the hands and arms, which makes it suitable for environments where texting using conventional methods would be impractical or dangerous (driving, walking, being in a meeting, being in a noisy environment with a lot of distractions etc).

It may seem that widespread adoption of the invented method will be complicated by the difficulty of learning the Morse code. However there are plenty of tutorial materials and learning aids helping the public to study Morse code. The adoption difficulty is further reduced by the fact that there is no need to study and practice Morse code listening/comprehension skill, the invented method only requiring learning Morse code for transmission, i.e. one-way communication.

### DETAILED DESCRIPTION OF THE INVENTION

The process of communication via text messages using a mobile device can be subdivided into the following tasks:

1. Getting an alert about a received incoming message.
2. Navigate the incoming messages (last/next/previous) and getting the content of the selected incoming message.
3. Navigate to and select a desired contact to initiate conversation with (other party).
4. Enter or exit the conversation with the selected party.
5. Compose the message to the other party in the conversation.
6. Review the content of the composed message, fully or partially, to verify that the text is correct.
7. Send the message to the other party.

To fulfill the tasks listed above the invented method assumes that the following equipment (the apparatus for eyes-free, quiet and partially hands-free texting) is available to the correspondent:

1. A mobile device connected to a network capable of sending and receiving text messages and equipped with a text-to-speech synthesizer (later called “the mobile device”).
2. An input device (Refs. 1 and 2) with a bare minimum amount of sensors capable of entering the Morse code symbols and a few control commands when manipulated by the correspondent “blindly” (without looking at the input device). The input device can be attached to, connected to, or built into the mobile device (1).
3. An audio output device, private or otherwise, attached to, connected to, or built into the mobile device (1).
4. A software program installed on the device (1) that enables the device to perform the tasks (1)-(7) above without using the correspondent's vision, voice and with only partial use of the user's one hand/arm.

This is how the tasks (1)-(7) are performed using the invented method of eyes-free, spoken voice-free, and for the most part hands-free texting with the equipment (1)-(4).

1. Getting an alert about a received incoming message.

This task is supported conventionally. When an incoming message is received by the device (1), an audio alert is played through the audio output (3), notifying the correspondent of a possibility to listen to the message and engage in a text conversation.

2. Navigate the incoming messages and get their content.

In one embodiment, the last received message is selected by default and the correspondent may immediately enter into the conversation. However if another conversation is desired, the user can manipulate the input device (2) to send navigation commands (such as “previous message” or “next message”). The selected message can be played through the audio output (3).

In addition, the messages can be searched or filtered for keywords or dates (with command “Search incoming messages”), where the required criteria are sent to the mobile device (1) in Morse code using the input device (2). Again, because the Morse code only has the two symbols “dot” and “dash”, the input device can have only a few sensors, allowing it to be used “blindly” without looking at the input device. As the text is entered, the correspondent can receive audio feedback on the characters being transmitted to the device and recognized. Once a word is finished, the software (4) can automatically give feedback on the completed word by synthesizing the word and playing it through the audio output (3). To correct the discovered mistakes, the correspondent can employ the input device commands “erase last character” or “erase last Word”. Given that all the feedback is being received via the audio, the eyes of the correspondent are freed for other tasks not related to the text messaging.

3. Navigate the contact list and select the desired contact. In the invented method this task is accomplished with a combined use of command sensors of the input device (2) and character input in Morse code. The input device (2) can recognize commands “contact list”, “search contacts”, “first/last contact”, “next/previous contact”. The command “search contacts” can be followed with character input in Morse code to fully or partially spell the contact name.
4. Enter or exit the conversation with the selected party. Once the party is selected, the message composition can immediately start. However the conversation can be abandoned at any point using an appropriate command “exit conversation” of the input device (2)
5. Compose a message to another party. In order to compose the message to the other party, the correspondent sends character data in Morse code using the input device (2), as described above.
6. Get the content of the composed message to verify that the text is correct.

The input command “play message” will cause the software (4) to play an entire message through the text-to-speech synthesizer of the device (1) through the audio output (3).

7. Send the message to the other party.

When the message is verified it can be sent using the command “send message” using the input device (2). This would cause the software (4) to send the message to the other party through the network connected to the device (1).

The following are descriptions of preferred embodiments of the apparatus for eyes-free texting.

1. A mobile device with function for sending and receiving text messages.

Any computer, mobile phone, mobile tablet, notebook or lapbook with a network connection can be used as the mobile device for eyes free texting. It is not necessary that the device is equipped with a touch sensitive screen (touch sensors) or with a built-in audio output component. Any of the devices presently used for text messages can also be used for eyes-free texting according to the invented method.

2. An input device that can be manually manipulated.

In one embodiment, provided that the device (1) is equipped with a touch-sensitive screen, the input device can be implemented as a set of touch buttons placed on the screen by the software running on the device (see Refs. 2 and 4). To further facilitate “blind” operation of the on-screen buttons, a special implement (for instance a plastic sheet with a pattern of cut out holes) can be placed on the screen to help locate the sensors. In another embodiment, for instance when use of touch screen is not desirable or not possible, a dedicated input device can be furnished to be attached or wirelessly connected to the device (1), as in Ref. 1 (see also Ref. 3). The dedicated input device can have several sensors or buttons enabling the user to enter the Morse symbols and the required commands. In yet another embodiment, a specialized set of buttons can be placed directly or indirectly on the steering wheel column of a vehicle in the manner similar to buttons of an audio system remote control.

3. An audio output device for playing the text messages and feedback

An audio output is required to be attached to, connected to, or built into the mobile device (1). Most of the devices currently already have a built-in audio output component. However, in order to conduct private conversation, it is not desirable that nearby individuals overhear the audio produced by the output. For these reasons or for any other reason, a personal audio device can be attached to or connected to the mobile device (1). In one embodiment, a personal wired headphones or earphones can serve as an audio device. In another embodiment, a Bluetooth-connected headphones or earphones can fulfill that function.

Note that the input device (2) and the audio output device (3) may not necessarily be two distinct physical components. In yet another embodiment, they can be combined into one external device connected to or attached to the mobile device (1).

4. A software program supporting the tasks (1)-(7).

To use the invented method for eyes-free texting, the software program should be installed and launched on the mobile device. The program should have access to the speech synthesizer of the mobile device (1) and to the input device (2). The program should also have means to interact with the standard text messaging software to retrieve received messages and send messages to the other party. This last function can be implemented by several means, such as retrieving the information from the device screen, interacting with a messaging program through an Application Program Interface (API), or having text messaging functions built into the program (4). The specific means of achieving this last function can be left to the practitioner skilled in the art of programming and is not relevant to the invented method.

FIG. 1 illustrates the work of the program (4) in one embodiment. FIG. 2 further illustrates the user interface of the program (4) in one embodiment.

### BRIEF DESCRIPTION OF THE DRAWINGS

FIG. 1. Diagram of operation of one embodiment of the software supporting the invented method of texting.

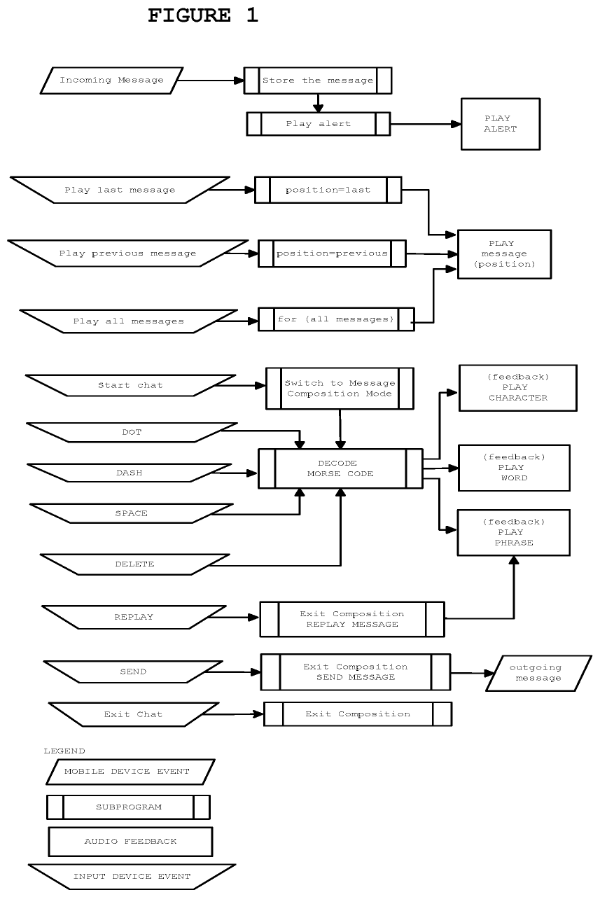

FIG. 2. One embodiment of the Graphical User Interface of the software supporting the invented method of texting.

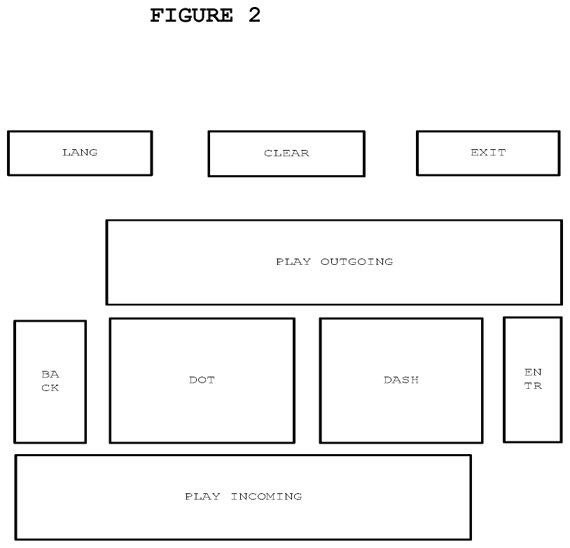

1. A method for sending and receiving text messages to/from another party using a mobile computer or a mobile phone (later called mobile device) where the correspondent inputs text by blindly and silently manipulating an input device having only a few input sensors due to utilization of the Morse code, reducing the entire alphabet to the two symbols “dot” and “dash”, and where the correspondent is receiving the incoming, outgoing and/or other feedback and guidance audio messages generated by a text-to-speech synthesizer of the mobile device through an audio reproduction system attached to, connected to, or built into the mobile device, the method comprising:
A method utilizing Morse code input and audio feedback output for composing and editing the text message content in the mobile device by “blindly” and “silently” manipulating an input device attached, built into or connected to the mobile device, the input device having very few input sensors due to the Morse code only having two symbols in its “alphabet”, and receiving feedback by listening to audio messages generated by the text-to-speech synthesizer of the mobile device through an audio reproduction system attached, connected, or built into the mobile device;
A further method utilizing Morse code and audio feedback for the purposes of blindly and silently navigating the correspondent parties directory or navigating the received messages, where the feedback and guidance audio messages are created by the text-to-speech synthesizer of the mobile device and played through an audio reproduction system built into, attached or connected wirelessly to the mobile device, and the navigation commands and search keywords and other search criteria data are entered using Morse code on an input device having very few sensors due to the Morse code only having two symbols in its “alphabet”.

2. An apparatus enabling the method of claim 1 comprising:
A mobile phone or mobile computer (the mobile device) of claim 1 enabled for wireless transmission of text messages to other parties;
An input control device of claim 1 either built into or wirelessly or otherwise connected to or attached to the mobile device, capable of being manually operated by the correspondent “blindly” (not looking at it) and “silently” (not speaking aloud) designed for entering text in the Morse code and/or issue very few additional control commands, the amount of sensors in the device being drastically reduced to allow blind manipulation due to the Morse code only having the two symbols “dot” and “dash” in its alphabet;
An audio reproduction system of claim 1 built into, attached or wirelessly or otherwise connected to the mobile device of claim 1 for relaying synthesized text messages (privately if desired) from the mobile device of claim 1 to the correspondent via audio channel (the correspondent's ears);
A software program running on the mobile device of claim 1 that enables the method for composing, sending and receiving text messages to/from the correspondent and another party (the method of claim 1), the program comprising:
A subprogram receiving the Morse code messages created by the correspondent utilizing the input device of claim 1;
A subprogram synthesizing voice messages and playing them through the audio reproduction system of claim 1 built into, attached or connected to the mobile device of claim 1;
A further subprogram capable of executing commands sent by the correspondent using the input device of claim 1;
A further controlling subprogram coordinating the overall functioning of the subprograms to enable the operation of the method of claim 1, generally consisting of steps of alerting the correspondent of incoming message received by the mobile computer or mobile phone from the other party, playing the incoming message, composing the draft reply message, editing the composed reply message, and sending the composed reply message to the other party, the described steps may optionally include steps of listing the correspondent directory, playing the summary information from the list of received messages, selecting the desired correspondent or desired message to be the recipient of the message being composed, entering or exiting the desired conversation, these additional steps supporting the need to proactively initiate a text message exchange or reply to a previously received message);
A further subprogram optionally communicating with the commercial-off-the-shelf messaging software installed on the mobile device in order to send and receive text messages to/from the recipient.
